(19) United States
(12) Patent Application Publication
(10) Pub. No.: US 2009/0239137 A1
(43) Pub. Date: Sep. 24, 2009

(54) BATTERY MODULE AND BATTERY PACK

(76) Inventors: Takeo Kakuchi, Chofu-shi (JP); Taihei Koyama, Tachikawa-shi (JP); Yosuke Tonami, Asaka-shi (JP); Takafumi Nakahama, Fuchu-shi (JP); Norihito Togashi, Yokohama-shi (JP); Kenji Sato, Hachioji-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/405,443

(22) Filed: Mar. 17, 2009

(30) Foreign Application Priority Data
Mar. 24, 2008 (JP) 2008-076580

(51) Int. Cl. H01M 6/42

(52) U.S. Cl. 429/151

(57) ABSTRACT

A battery pack provided with a battery module including a projection, a support which holds the respective projections of a plurality of the battery modules disposed so that the projections are arranged in a straight line, and a fixing member for fixing the support to the projections.

### CROSS-REFERENCE TO RELATED APPLICATIONS

This application is based upon and claims the benefit of priority from prior Japanese Patent Application No. 2008-076580, filed Mar. 24, 2008, the entire contents of which are incorporated herein by reference.

### BACKGROUND OF THE INVENTION

1. Field of the Invention

This invention relates to a battery pack, and more particularly, to a battery pack in which a plurality of battery modules, each including a secondary battery (cell) such as a lithium-ion battery, using a non-aqueous electrolyte and contained in a case, are fixedly arranged in a straight line.

2. Description of the Related Art

In recent years, non-aqueous secondary batteries, especially lithium-ion batteries, have been noted as energy sources for driving vehicles, such as electric vehicles, as well as ones for cordless, portable electronic devices.

Disclosed in Jpn. Pat. Appln. KOKAI Publication No. 2005-268004 (Patent Document 1), for example, is an electricity storage device composed of flat laminated batteries for use as electricity storage cells and an armor case that contains the laminated batteries.

Disclosed in Japanese Patent No. 3350189 (Patent Document 2), moreover, is a battery box unit for an electric vehicle in which a drive power source composed of a plurality of batteries are contained in a battery box.

### BRIEF SUMMARY OF THE INVENTION

The object of this invention is to provide a battery pack configured so that a plurality of battery modules can be easily fixed and an operator's load can be reduced.

A battery pack according to a first aspect of the invention comprises: a battery module including a projection; a support which holds the respective projections of a plurality of the battery modules disposed so that the projections are arranged in a straight line; and a fixing member for fixing the support to the projections.

A battery pack according to a second aspect of the invention comprises: a battery module; a housing which contains a plurality of the battery modules disposed in a straight line between a first fixing plate extending substantially at right angles from a bottom plate and a tapered second fixing plate extending substantially at right angles from the bottom plate and reduced in thickness with distance from the bottom plate; a wedge member interposed between the battery module and the second fixing plate of the housing; and a fixing member for fixing the wedge member to the housing.

A battery pack according to a third aspect of the invention comprises: a battery module; a fixing plate; a movable pressure plate opposed to the fixing plate; and an urging member which urges the pressure plate toward the fixing plate so as to hold the battery modules arranged in a straight line between the fixing plate and the pressure plate, thereby fixing the battery modules.

A battery pack according to a fourth aspect of the invention comprises: a battery module provided with a case including an open portion and a cell contained in the case; and a lid member fitted to the case of each of a plurality of battery modules arranged in a straight line, thereby closing the open portion and fixing the battery modules.

A battery pack according to a fifth aspect of the invention comprises: a battery module provided with a cell, which is composed of an electrode group and a non-aqueous electrolyte contained in an armor case and includes a cell terminal electrically connected to the electrode group and protruding outward from the armor case, and a case including a cell containing portion which contains the cell and a terminal hole through which the cell terminal of the cell projects; a connecting member which is electrically connected to the cell terminal projecting through the terminal hole of the case of each of a plurality of battery modules arranged in a straight line and electrically connects the adjacent battery modules; and a fixing member for fixing the connecting member to the case of each of the battery modules.

According to this invention, there may be provided a battery pack configured so that a plurality of battery modules can be easily fixed and an operator's load can be reduced.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view schematically showing the basic structure of a battery module according to an embodiment of the invention;

FIG. 2 is a perspective view schematically showing the basic structure of the battery module shown in FIG. 1;

FIG. 3 is a perspective view schematically showing the construction of a battery pack according to a first embodiment;

FIG. 4 is a perspective view schematically showing an external appearance of a plurality of battery modules of the battery pack shown in FIG. 3 arranged in a line;

FIG. 5 is a perspective view schematically showing the construction of a support applicable to the battery pack shown in FIG. 3;

FIG. 6 is a perspective view schematically showing a state in which the battery pack shown in FIG. 3 is secured to a housing;

FIG. 7 is a perspective view schematically showing the construction of a current lead applicable to each battery module of the battery pack according to the first embodiment;

FIG. 8 is a perspective view schematically showing the construction of another support applicable to the battery pack shown in FIG. 3;

FIG. 9 is a sectional view schematically showing a state in which the support shown in FIG. 8 is attached to a case;

FIG. 10 is a perspective view schematically showing the construction of a battery pack according to a second embodiment;

FIG. 11 is a perspective view schematically showing the construction of a battery pack according to a third embodiment;

FIG. 12 is a side view schematically showing the construction of the battery pack according to the third embodiment;

FIG. 13 is perspective view schematically showing the constructions of a fixing plate and pressure plate applicable to the battery pack according to the third embodiment;

FIG. 14 is a perspective view schematically showing the construction of a battery pack according to a fourth embodiment;

FIG. 15 is an exploded perspective view schematically showing the construction of the battery pack according to the fourth embodiment;

FIG. 16 is a perspective view schematically showing the construction of a battery pack according to a fifth embodiment;

FIG. 17 is a perspective view schematically showing the construction of a connecting member applicable to the battery pack according to the fifth embodiment; and

FIG. 18 is a sectional view schematically showing a state in which the connecting member shown in FIG. 17 is attached to a case.

### DETAILED DESCRIPTION OF THE INVENTION

A battery pack according to an embodiment of this invention will now be described with reference to the accompanying drawings.

The basic structure of a battery module incorporated in the battery pack will be described first.

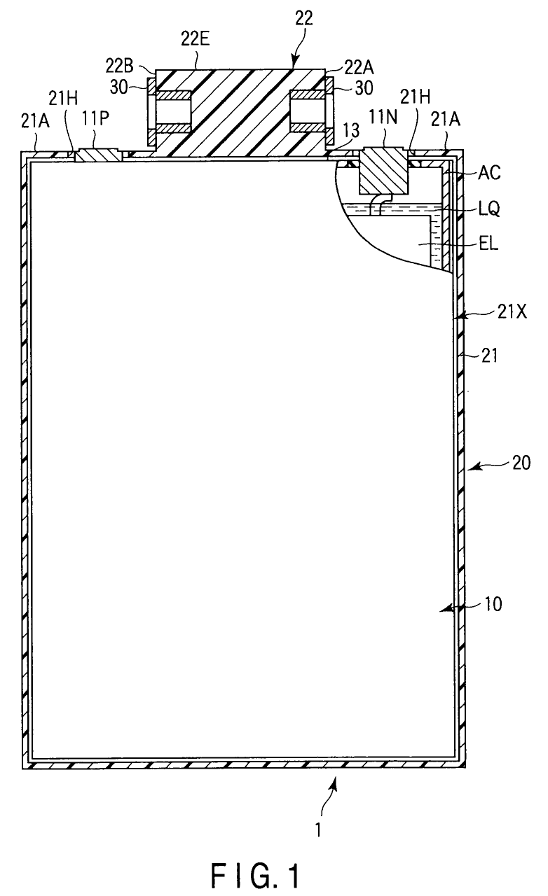

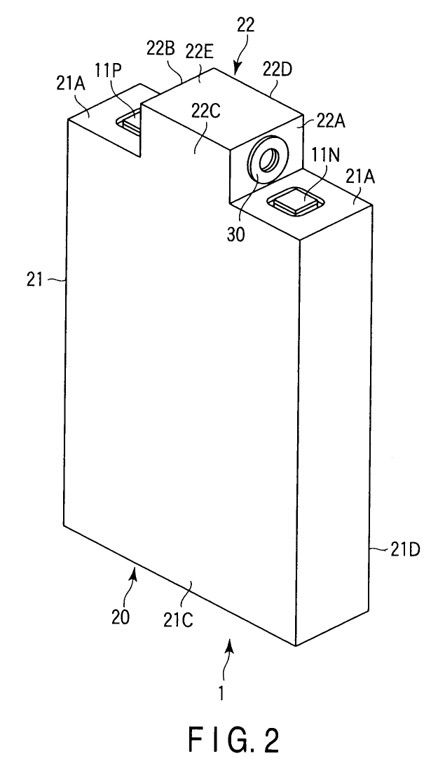

As shown in FIGS. 1 and 2, a battery module 1 is composed of a cell 10 and case 20 that accommodates the cell 10.

Specifically, the cell 10 is a secondary battery such as a lithium-ion battery, which uses a non-aqueous electrolyte LQ, and is designed so that an electrode group EL and non-aqueous electrolyte LQ are hermetically sealed in an armor case AC. The external shape of the cell 10 (i.e., that of the armor case AC) is substantially rectangular-parallelepipedic.

The electrode group EL includes positive and negative electrodes that are coiled with a separator between them and has a radially compressed, flat rectangular shape. A cell terminal 11 is electrically connected to the electrode group EL constructed in this manner. Positive and negative terminals 11P and 11N are electrically connected to the positive and negative electrodes, respectively, of the electrode group EL. The positive and negative terminals 11P and 11N both protrude outward from one surface (upper surface) 13 of the armor case AC.

The case 20 is provided with a case body 21 that includes a cell containing portion 21X and a projection 22 that protrudes from the case body 21. The case 20 is formed of a resin, such as polycarbonate (PC) or polyphenylene sulfide (PPS) resin, or ceramic. The projection 22 corresponds to a projection of the battery module 1.

The case body 21 is substantially rectangular-parallelepipedic and includes six wall plates that enclose the cell 10. The cell containing portion 21X is equivalent to a substantially rectangular-parallelepipedic hollow portion formed inside the case body 21 and larger than the contour of the cell 10. These six wall plates may be formed integrally with one another, or alternatively, at least one wall plate may be joined to another one by screwing or by means of a fitting structure. One wall plate 21A that constitutes the case body 21 is formed with two terminal holes 21H into which the positive and negative terminals 11P and 11N of the cell 10 can be inserted.

When the cell 10 is contained in the case body 21, a small gap for the passage of a coolant (e.g., cold blast) is formed between the cell 10 and case body 21. Further, the positive and negative terminals 11P and 11N that are inserted individually into the terminal holes 21H project outward from the wall plate 21A, so that they can be connected to current leads.

The projection 22 protrudes outward (i.e., oppositely from the cell containing portion 21X) from the wall plate 21A. In this embodiment, the projection 22 is substantially rectangular-parallelepipedic and includes a top wall 22E and four sidewalls 22A, 22B, 22C and 22D that rise outward from the wall plate 21A. The four sidewalls 22A to 22D and top wall 22E are substantially rectangular. The projection 22 is not limited to this illustrated shape but may be of another shape.

The sidewalls 22A and 22B face each other. The sidewall 22A extends substantially at right angles to the wall plate 21A from which the positive terminal 11P projects. The sidewall 22B extends substantially at right angles to the wall plate 21A from which the negative terminal 11N projects. The sidewalls 22C and 22D face each other and both connect with the sidewalls 22A and 22B. Further, the sidewalls 22C and 22D are formed integrally and flush with wall plates 21C and 21D, respectively, of the case body 21. The top wall 22E connects with the four sidewalls 22A to 22D.

Further, the projection 22 is provided with inserts 30. The inserts 30 extend individually from the sidewalls 22A and 22B into the projection 22. An internal thread is formed on the inner surface of each insert 30. These inserts 30 are formed of a metal, such as brass.

The following is a detailed description of embodiments of a specific construction of a battery pack CP.

### First Embodiment

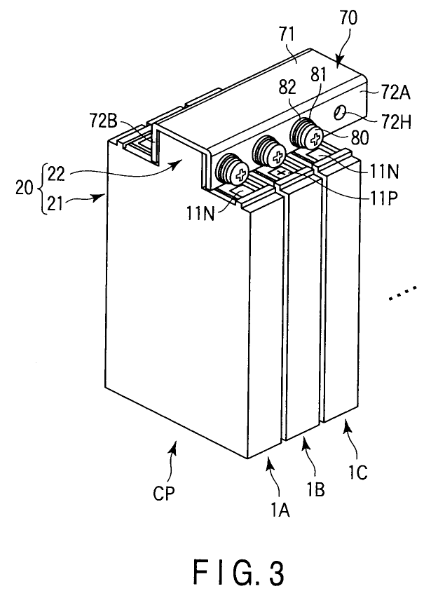

In a first embodiment, as shown in FIG. 3, the battery pack CP is composed of a plurality of battery modules 1A, 1B, 1C . . . , support 70, and fixing members 80.

The battery modules 1A, 1B, 1C . . . are disposed so that their respective projections 22 are arranged in a straight line in the order named.

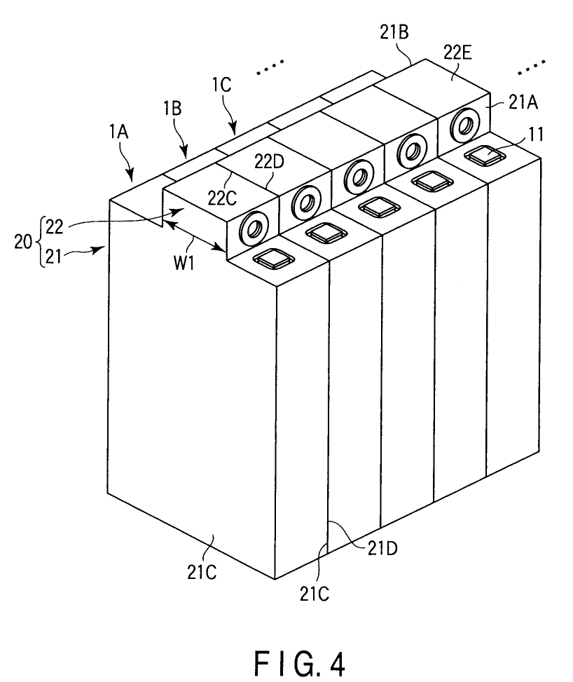

More specifically, as shown in FIG. 4, the battery modules 1A, 1B, 1C . . . are arranged so that their respective cases 20 face one another. The wall plate 21D of the case body 21 and the sidewall 22D of the projection 22 of, for example, the battery module 1A face the wall plate 21C of the case body 21 and the sidewall 22C of the projection 22, respectively, of the battery module 1B. As in the example shown in FIG. 4, the respective cases 20 of each two adjacent ones of the battery modules 1A, 1B and 1C may be in close contact with each other.

In this state, the respective cell terminals 11 of the battery modules 1A, 1B and 1C are arranged in a straight line parallel to the direction of arrangement of the projections 22. Further, the battery modules 1A, 1B and 1C may be electrically connected in series or in parallel. If they are connected in series, for example, the battery modules 1A, 1B and 1C are arranged so that the cell terminals of the adjacent battery modules are different in polarity.

The support 70 holds the respective projections 22 of the battery modules 1 arranged in a straight line.

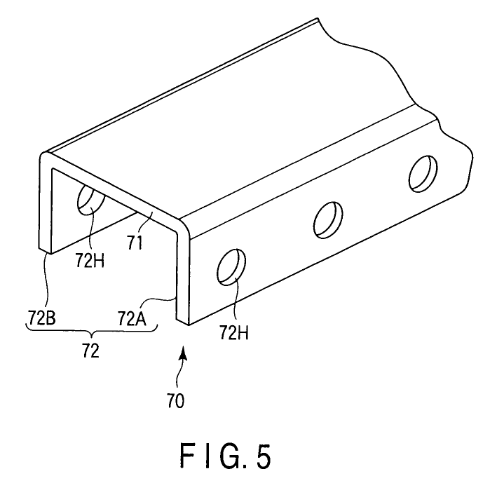

More specifically, as shown in FIG. 5, the support 70 can be formed by, for example, bending one plate material. This support 70 is substantially U-shaped and integrally includes an intermediate portion 71 and a pair of clamping portions 72.

The intermediate portion 71 is substantially rectangular and is situated between the pair of clamping portions 72. The intermediate portion 71 faces the respective top walls 22E of the held projections 22. Further, the width of the intermediate portion 71 is equal to a width W1 of each projection 22.

The clamping portions 72 include first and second clamping portions 72A and 72B. The first and second clamping portions 72A and 72B are connected individually to the opposite ends of the intermediate portion 71. Each of the clamping portions 72A and 72B is substantially rectangular. Further, the clamping portions 72A and 72B face each other at a distance equal to the width W1 of each projection 22. Thus, the first and second clamping portions 72A and 72B clamp the projections 22 between them. The first clamping portion 72A faces the respective sidewalls 22A of the held projections 22. The second clamping portion 72B faces the respective sidewalls 22B of the held projections 22.

Like the sidewalls 22A and 22B of the projection 22 that extend substantially at right angles to the top wall 22E, the first and second clamping portions 72A and 72B extend substantially at right angles to the intermediate portion 71. Thus, the clamping portions 72A and 72B face each other in substantially a parallel relationship.

Further, each of the first and second clamping portions 72A and 72B has an opening 72H into which each screw 80 as an example of a fixing member can be inserted. A plurality of openings 72H formed in the first clamping portion 72A communicate individually with the inserts 30 on the respective sidewalls 22A of the battery modules when the first clamping portion 72A faces the sidewalls 22A. Further, a plurality of openings 72H formed in the second clamping portion 72B communicate individually with the inserts 30 on the respective sidewalls 22B of the battery modules when the second clamping portion 72B faces the sidewalls 22B.

Each screw 80 is inserted into the opening 72H in each of the first and second clamping portions 72A and 72B with the aid of, for example, a spring washer 81 and flat washer 82 and is tightened to each corresponding insert 30. Thus, the support 70 is secured to the respective projections 22 of the battery modules 1A, 1B, 1C . . . . At the same time, the battery modules 1A, 1B, 1C . . . can be integrally held and fixed on one another.

According to the first embodiment arranged in this manner, the battery modules 1A, 1B, 1C . . . are disposed so that their respective projections 22 are arranged in a straight line. Therefore, the projections 22 can be easily held by means of the support 70, and the support 70 can be secured to all the projections 22 by means of the fixing members 80. In other words, the plurality of battery modules 1A, 1B, 1C . . . can be easily fixed on one another by using the one support 70. The battery modules 1A, 1B, 1C . . . fixed in this manner can be handled with ease, since they are disposed so as to constitute the battery pack CP. Further, the operating efficiency can be improved, and an operator's load can be reduced.

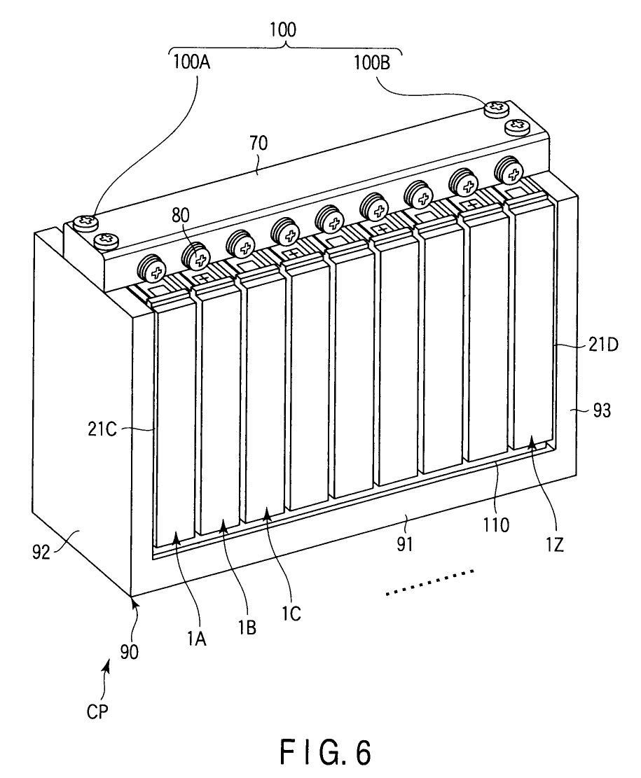

In the first embodiment described above, the battery pack CP may be constructed further including a housing 90, which contains the battery modules 1A, 1B, 1C . . . fixed by means of the support 70, and housing fixing members 100 that secure the support 70 to the housing 90, as shown in FIG. 6.

The housing 90 includes a flat bottom plate 91, flat first fixing plate 92 extending substantially at right angles from the bottom plate 91, and flat second fixing plate 93 opposed to the first fixing plate 92 and extending at right angles from the bottom plate 91. In the example shown in FIG. 6, the housing 90 is a substantially U-shaped structure formed of the bottom plate 91 and first and second fixing plates 92 and 93. Alternatively, however, the housing 90 may be, for example, box-like.

The first fixing plate 92 faces the wall plate 21C of the case body 21 of the battery module 1A that, among the plurality of battery modules 1A, 1B, 1C . . . arranged in a line, is located on one end side. Further, the second fixing plate 93 faces the wall plate 21D of the case body 21 of a battery module 1Z that, among the battery modules 1A, 1B, 1C . . . arranged in a line, is located on the other end side. The first and second fixing plates 92 and 93 face each other in substantially a parallel relationship at a distance equal to the total thickness of the battery modules 1A, 1B, 1C . . . between them.

A screw 100A as an example of the housing fixing member 100 is tightened to the first fixing plate 92 through the support 70, thereby securing the support 70 to the first fixing plate 92. A screw 100B as another example of the housing fixing member 100 is tightened to the second fixing plate 93 through the support 70, thereby securing the support 70 to the second fixing plate 93.

Thus, the battery modules 1A, 1B, 1C . . . fixed by means of the support 70 are united with the housing 90 in such a manner that their respective bottom surfaces are pressed against the bottom plate 91 of the housing 90. Accordingly, the battery modules 1A, 1B, 1C . . . can be firmly fixed to the housing 90. Further, the battery modules 1A, 1B, 1C . . . are supported by the support 70 and housing 90. Since the battery modules 1A, 1B, 1C . . . are sandwiched between the first and second fixing plates 92 and 93, in particular, the cell can be kept from bulging along its thickness (or in the direction of arrangement of the battery modules).

Furthermore, an elastic member 110 may be interposed between the housing 90 and battery modules 1A, 1B, 1C . . . . The elastic member 110 is, for example, a rubber sheet. Specifically, the elastic member 110 should be located between the bottom plate 91 of the housing 90 and the respective bottom surfaces of the battery modules 1A, 1B, 1C . . . .

Thus, dimensional errors of the battery modules 1A, 1B, 1C . . . can be absorbed, so that the individual battery modules can be fixed to the housing 90 with uniform force. If any external force, such as vibration or impact, is applied to the battery modules 1A, 1B, 1C . . . , moreover, a load acting on the battery modules, especially on the cell 10, can be reduced.

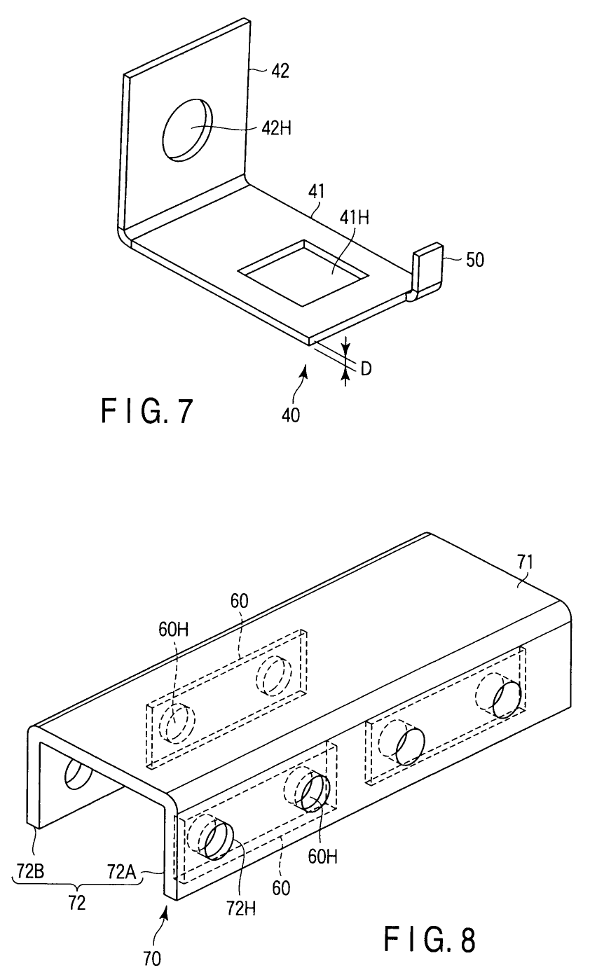

In the first embodiment described above, the battery pack CP may be constructed further including current leads 40 and connecting members 60 embedded in the support 70, as shown in FIGS. 7 to 9.

Specifically, each current lead 40 is bent along the contour of each projection 22. The current lead 40 can be formed by, for example, bending a plate of an electrically conductive material. For example, the lead 40 is a substantially L-shaped structure integrally including a junction 41 and an extending portion 42.

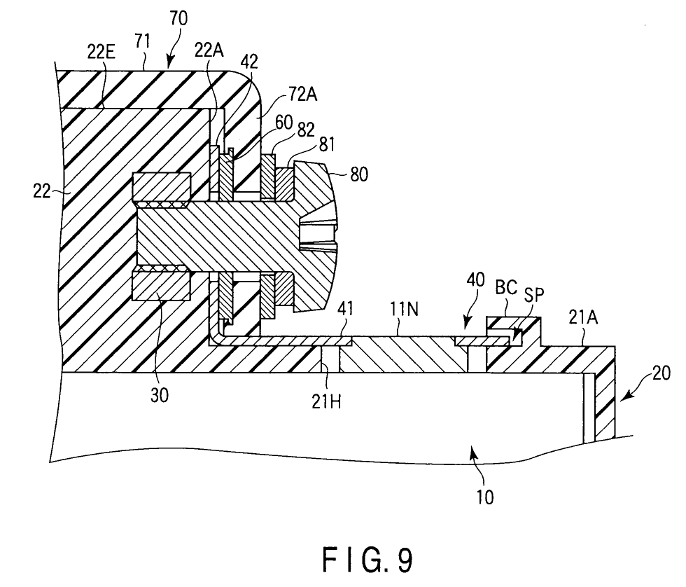

More specifically, the junction 41 is substantially rectangular and faces the wall plate 21A of the case body 21. The junction 41 has an opening 41H into which the cell terminal 11 projecting from the wall plate 21A can be inserted. The junction 41 is electrically connected to the cell terminal 11 in the opening 41H by welding or the like. Although only the region where the negative terminal 11N as a cell terminal and the current lead 40 are connected is illustrated in FIG. 9, it is to be understood that the lead 40 is also connected to the positive terminal 11P.

One end of the extending portion 42 is connected to that of the junction 41. The extending portion 42 is substantially rectangular and faces the sidewall 22A of the projection 22. Like the sidewall 22A that extends substantially at right angles to the wall plate 21A, the extending portion 42 extends substantially at right angles to the junction 41. Further, the extending portion 42 has an opening 42H into which each screw 80 to be tightened to each insert 30 can be inserted. When the projection 22 is held in the support 70, the extending portion 42 extends between the projection 22 and support 70.

Although the junction 41 is provided, on its other end, with a voltage terminal 50 extending substantially at right angles to it, the terminal 50 is not essential.

On the other hand, the body 21 of the case 20 includes a bag-like fitting portion BC to which the junction 41 is fitted. The fitting portion BC protrudes from the wall plate 21A and includes a gap SP on the side where it faces the projection 22. The gap SP has a height greater than a thickness D of the junction 41. Thus, the other end of the junction 41 can be fitted and held in the gap SP of the fitting portion BC. If the voltage terminal 50 is disposed on the other end of the junction 41, it extends without being fitted to the fitting portion BC.

The connecting members 60 are embedded in that surface of the support 70 which faces the current leads 40. Specifically, the connecting members 60 are embedded in that surface of each of the first and second clamping portions 72A and 72B which faces the projections 22. Each connecting member 60 is a plate that extends in the direction of arrangement of the battery modules 1A, 1B, 1C . . . and is in contact with each two or more adjacent current leads 40.

Further, each connecting member 60 has an opening 60H into which each screw 80 can be inserted. The opening 60H communicates with its corresponding one of the openings 72H in the first and second clamping portions 72A and 72B.

In this arrangement, the screws 80 are inserted individually into the respective openings 42H of the current leads 40 through the openings 72H of the first and second clamping portions 72A and 72B and the openings 60H of the connecting members 60 with the aid of, for example, the spring washers 81 and flat washers 82, and are tightened to their corresponding inserts 30.

Accordingly, the battery modules 1A, 1B, 1C . . . can be integrally held and fixed on one another, and each two adjacent battery modules can be electrically connected to each other. The example shown in FIG. 8 corresponds to the case where the battery modules 1A, 1B, 1C . . . are connected in series. Specifically, the current lead 40 connected to the cell terminal 11N of the battery module 1A and the lead 40 connected to the cell terminal 11P of the adjacent battery module 1B are electrically connected to each other by the corresponding connecting member 60.

Thus, the battery modules can be electrically connected to one another as they are fixed together, so that the number of assembly processes can be reduced, the operating efficiency can be improved, and the operator's load can be reduced.

### Second Embodiment

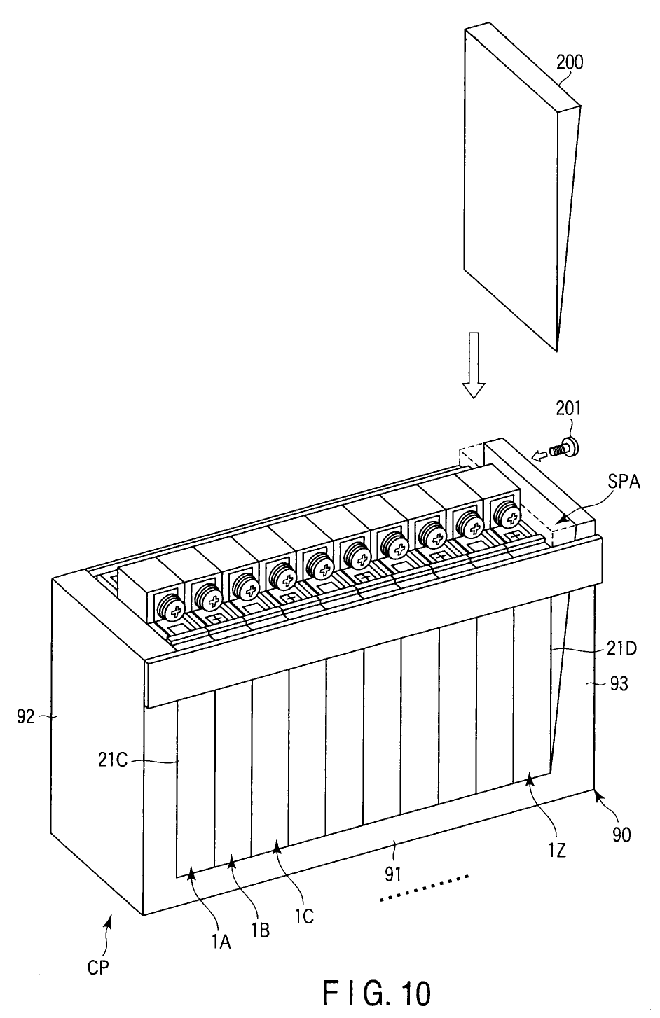

In a second embodiment, as shown in FIG. 10, the battery pack CP is composed of a plurality of battery modules 1A, 1B, 1C . . . , housing 90, and fixing member 201.

The battery modules 1A, 1B, 1C . . . are arranged in a straight line in the order named.

The housing 90, which contains the battery modules arranged in a straight line, includes a flat bottom plate 91, flat first fixing plate 92 extending substantially at right angles from the bottom plate 91, and tapered second fixing plate 93 opposed to the first fixing plate 92 and extending at right angles from the bottom plate 91. The second fixing plate 93 is tapered so that its thickness is reduced with distance from the bottom plate 91. In the example shown in FIG. 10, the housing 90 is a substantially U-shaped structure formed of the bottom plate 91 and first and second fixing plates 92 and 93. Alternatively, however, the housing 90 may be, for example, box-like, provided that the second fixing plate 93 is tapered.

The first fixing plate 92 faces a wall plate 21C of a case body 21 of the battery module 1A located on one end side. Further, the second fixing plate 93 faces a wall plate 21D of the case body 21 of a battery module 1Z located on the other end side so that a wedge-shaped space SPA is formed between the plates 93 and 21D.

The length of the bottom plate 91 between the first and second fixing plates 92 and 93 is equal to the total thickness of the battery modules 1A, 1B, 1C . . . between them. The fixing plates 92 and 93 face each other in substantially a parallel relationship at this distance.

A wedge member 200 is shaped corresponding to the space SPA between the second fixing plate 93 and the wall plate 21D of the battery module 1Z. The wedge member 200 is inserted between the second fixing plate 93 and battery module 1Z.

A screw 201 as an example of the fixing member is tightened to the wedge member 200 through the second fixing plate 93, thereby fixing the wedge member 200 and second fixing plate 93 to each other.

Thus, force can be applied to bring the battery modules 1A, 1B, 1C . . . into close contact with one another as they are secured to the housing 90. Since the battery modules 1A, 1B, 1C . . . are sandwiched between the first and second fixing plates 92 and 93 and wedge member 200, moreover, the cell can be kept from bulging along its thickness.

As in the example shown in FIG. 6, furthermore, an elastic member 110 may be interposed between the housing 90 and the battery modules 1A, 1B, 1C . . . . In this case, the elastic member 110 should be located between the bottom plate 91 of the housing 90 and the respective bottom surfaces of the battery modules 1. Thus, the same effect as in the example shown in FIG. 6 can be obtained.

Also in this second embodiment, the support 70 shown in FIG. 3 may be used so that the support 70 and housing 90 are fixed together. Further, the battery modules may be electrically connected to one another by using current leads 40, such as the one shown in FIG. 7, and a support 70 with connecting members 60 embedded therein, such as the one shown in FIG. 8.

### Third Embodiment

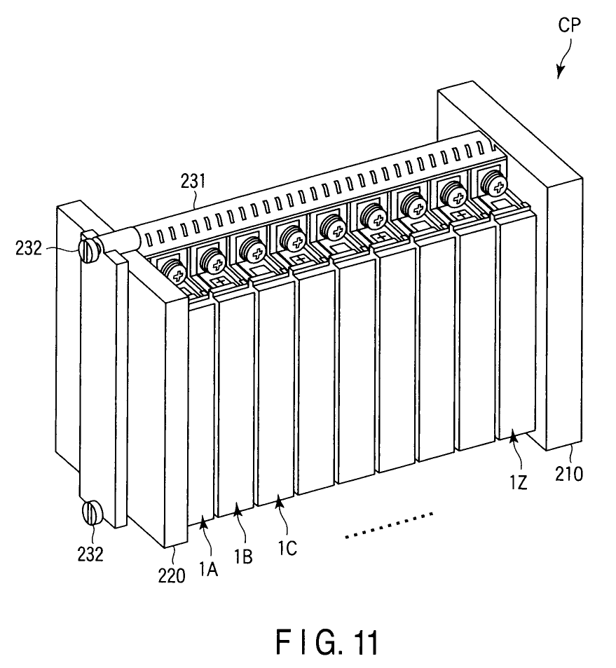

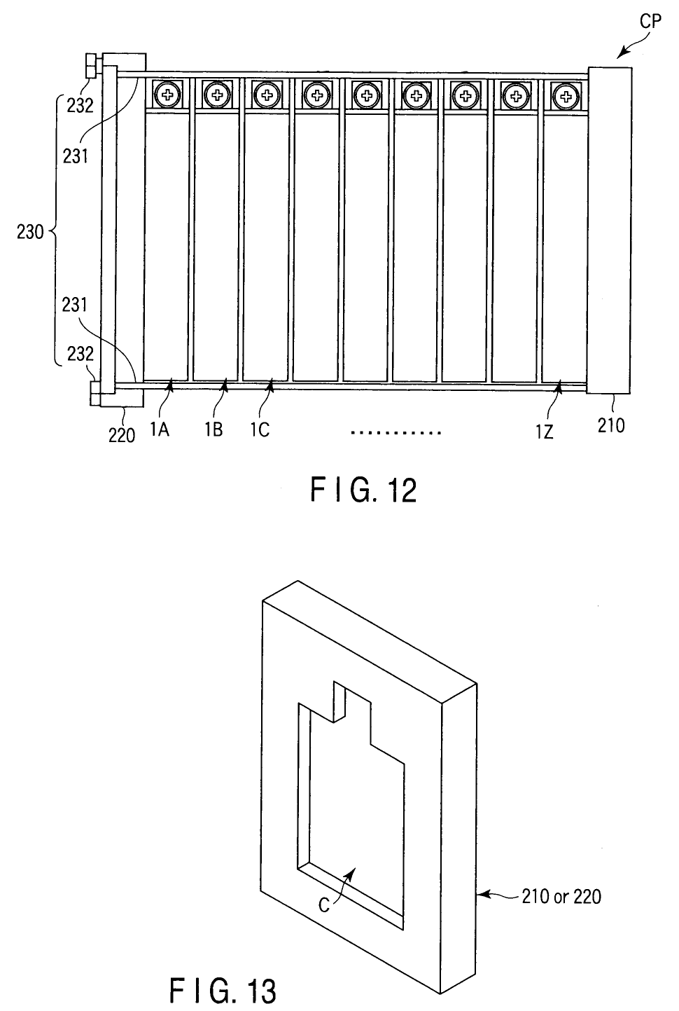

In a third embodiment, as shown in FIGS. 11 and 12, the battery pack CP is composed of a plurality of battery modules 1A, 1B, 1C . . . , fixing plate 210, pressure plate 220, and urging member 230.

The battery modules 1A, 1B, 1C . . . are arranged in a straight line in the order named.

The fixing plate 210 and pressure plate 220 are substantially uniform in thickness. The pressure plate 220 is opposed to the fixing plate 210 in substantially a parallel relationship at a predetermined distance and is configured for movement. The fixing plate 210 faces a battery module 1Z located on the other end side. Further, the pressure plate 220 faces the battery module 1A on one end side.

As shown in FIGS. 13, for example, the fixing plate 210 and pressure plate 220 should each be provided with a recess C that is shaped corresponding to the contour of the battery module 1A or 1Z so that a part of the battery module can be fitted therein.

The urging member 230 is composed of, for example, bands 231 spanning between the fixing plate 210 and pressure plate 220 and band tightening screws 232 for tensioning the bands 231. By tightening the screws 232, according to this arrangement, the pressure plate 220 can be urged toward the fixing plate 210 so as to hold the battery modules 1A, 1B, 1C . . . in a straight line between the plates 210 and 220, thereby fixing the battery modules. Since the battery modules 1A, 1B, 1C . . . are sandwiched between the fixing plate 210 and pressure plate 220, moreover, the cell can be kept from bulging along its thickness.

Since the fixing plate 210 and pressure plate 220 are each provided with the recess C that is shaped corresponding to the contour of the battery module 1, furthermore, the connected battery modules can be kept from moving at right angles to their thickness. Thus, the battery modules can be fixed more firmly.

Also in this third embodiment, the support 70 shown in FIG. 3 may be used so that the support 70 and a housing 90 are fixed together. Further, the battery modules may be electrically connected to one another by using current leads 40, such as the one shown in FIG. 7, and support 70 with connecting members 60 embedded therein, such as the one shown in FIG. 8.

### Fourth Embodiment

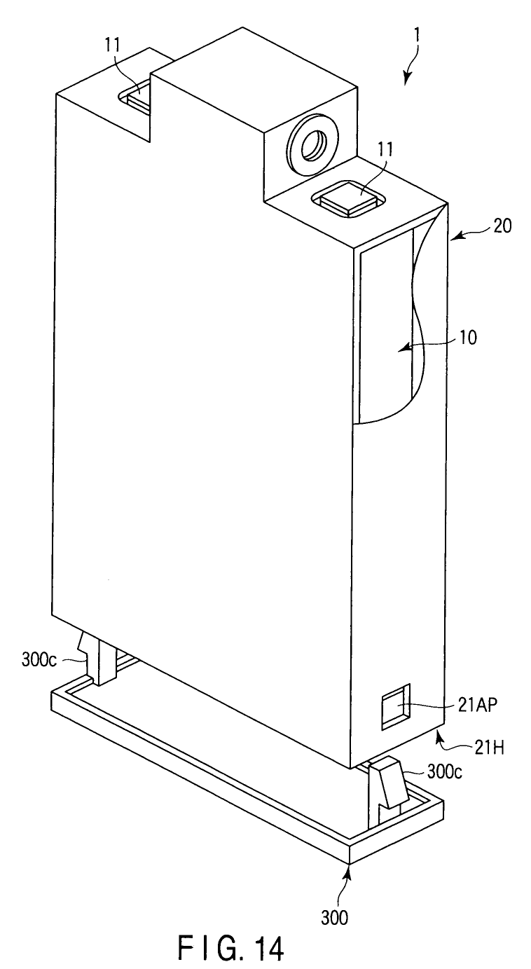

As shown in FIG. 14, each battery module 1 according to a fourth embodiment is provided with a cell 10 and case 20 that contains the cell 10.

The case 20 includes an open portion 20H. In this embodiment, the open portion 20H is formed at the bottom of the case 20, that is, on the side opposite a wall plate 21A from which cell terminals 11 project. Further, the case 20 has fitting holes 20AP in the vicinity of the open portion 20H.

The battery module 1 is further provided with a lid member 300 that is fitted to the case 20 and closes the open portion 20H. The lid member 300 includes lugs 300C that engage with the fitting holes 20AP, individually.

In this arrangement, the cell 10 is inserted into the case 20 through the open portion 20H. When the lugs 300C of the lid member 300 engage individually with the fitting holes 20AP of the case 20, the open portion 20H of the case 20 is closed so that the cell 10 is contained in the case 20. Thus, the number of assembly processes for the battery modules can be reduced.

The following is a description of a battery pack CP provided with a plurality of battery modules 1 that each include the cell 10 and case 20 connected in the aforementioned manner.

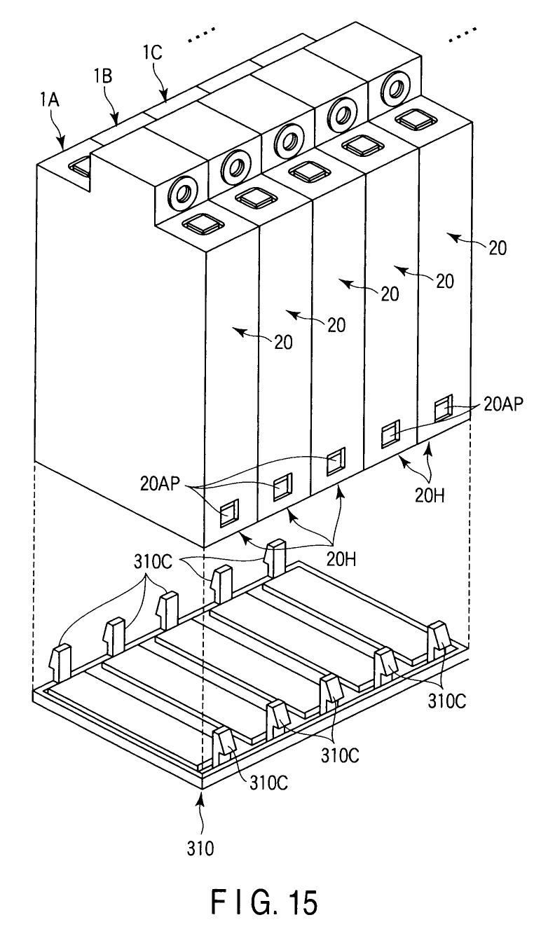

As shown in FIG. 15, the battery pack CP is composed of a plurality of battery modules 1A, 1B, 1C . . . and lid member 310.

The lid member 310 engages with the case 20 of each of the battery modules 1A, 1B, 1C . . . arranged on a straight line so as to close the open portion 20H and fixes the battery modules together. Specifically, the lid member 310 includes lugs 310C that engage individually with the fitting holes 20AP in the respective cases 20 of the battery modules.

After the cell 10 is inserted into each case 20 through the open portion 20H, according to this arrangement, the lugs 310C of the lid member 310 engage individually with the fitting holes 20AP of the cases 20. Thereupon, the open portion 20H of each case 20 is closed so that the cell 10 is contained in the case 20, and the battery modules 1A, 1B, 1C . . . are connected together by the lid member 310.

Thus, the number of assembly processes for the battery modules can be reduced.

Further, the aforementioned lid member 310 may be used in place of the bottom plate 91 of the housing 90 described in connection with the first and second embodiments. Thus, the battery modules 1A, 1B, 1C . . . can be easily secured to the housing 90.

As in the example shown in FIG. 6, moreover, an elastic member 110 may be interposed between the lid member 310 and battery modules 1A, 1B, 1C . . . . It is effective, in particular, to locate the elastic member 110 between the lid member 310 of the housing 90 and the respective bottom surfaces of the battery modules 1A, 1B, 1C . . . . Thus, the same effect as in the example shown in FIG. 6 can be obtained.

Also in this fourth embodiment, the support 70 shown in FIG. 3 may be used so that the support 70 and housing 90 are fixed together. Further, the battery modules may be electrically connected to one another by using current leads 40, such as the one shown in FIG. 7, and a support 70 with connecting members 60 embedded therein, such as the one shown in FIG. 8.

### Fifth Embodiment

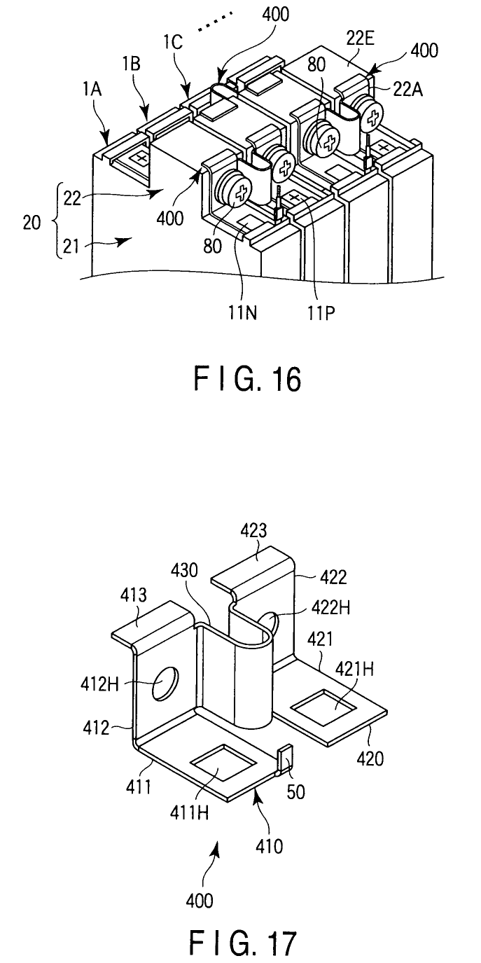

In a fifth embodiment, as shown in FIG. 16, the battery pack CP is composed of a plurality of battery modules 1A, 1B, 1C . . . , connecting members 400, and fixing members 80.

The battery modules 1A, 1B, 1C . . . are disposed so that their respective projections 22 are arranged in a straight line in the order named. The individual battery modules 1A, 1B, 1C . . . are constructed in the same manner as the ones described above.

For each of the battery modules 1A, 1B, 1C . . . arranged in a straight line, each connecting member 400 is electrically connected to a cell terminal 11 that projects from a terminal hole 21H of a case 20 and electrically connects each two adjacent battery modules.

Specifically, the connecting member 400 includes a first current lead 410 electrically connected to the cell terminal 11 of the one battery module 1A, second current lead 420 electrically connected to the cell terminal 11 of the battery module 1B that adjoins the battery module 1A, and coupling portion 430 that connects the first and second current leads 410 and 420.

The first and second current leads 410 and 420 and coupling portion 430 are formed of an electrically conductive material, and the coupling portion 430 electrically connects the current leads 410 and 420.

The first current lead 410 integrally includes a junction 411, intermediate portion 412, and extending portion 413 and is substantially Z-shaped. Likewise, the second current lead 420 integrally includes a junction 421, intermediate portion 422, and extending portion 423 and is substantially Z-shaped. The first and second current leads 410 and 420 have substantially the same construction. The first current lead 410 will now be described further in detail.

The junction 411 is substantially rectangular and faces a wall plate 21A of a case body 21. The junction 411 has an opening 411H into which a cell terminal projecting from the wall plate 21A can be inserted. The junction 411 is electrically connected to the cell terminal in the opening 411H by welding or the like.

One end of the intermediate portion 412 is connected to that of the junction 411. The intermediate portion 412 is substantially rectangular and faces a sidewall 22A of the projection 22. Like the sidewall 22A that extends substantially at right angles to the wall plate 21A, the intermediate portion 412 extends substantially at right angles to the junction 411. Further, the intermediate portion 412 has an opening 412H into which a screw 80 as an example of a fixing member to be tightened to an insert 30 can be inserted.

The one end of the extending portion 413 is connected to the other end of the intermediate portion 412. The extending portion 413 is substantially rectangular and faces a top wall 22E of the projection 22. Like the top wall 22E that extends substantially at right angles to the sidewall 22A, the extending portion 413 extends substantially at right angles to the intermediate portion 412.

Although the junction 411 is provided, on its other end, with a voltage terminal 50 extending substantially at right angles to it, the terminal 50 is not essential.

The coupling portion 430 is substantially U-shaped and is connected to the intermediate portion 422 of the second current lead 420 as well as to the intermediate portion 412 of the first current lead 410.

In this arrangement, the screws 80 are tightened to their corresponding inserts 30 through the respective openings 412H and 422H of the first and second current leads 410 and 420 with the aid of, for example, spring washers 81 and flat washers 82.

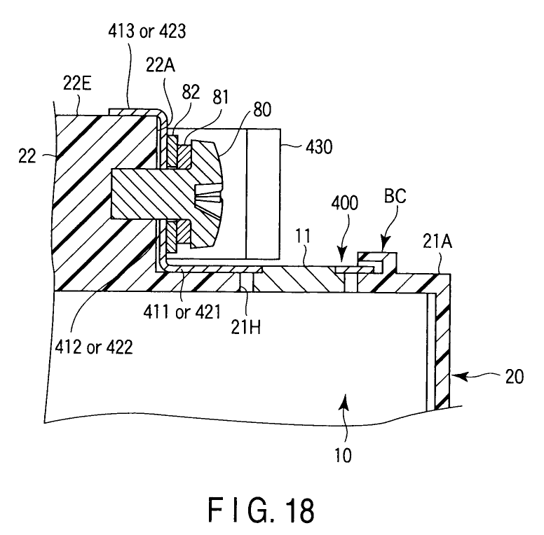

Accordingly, the battery modules 1A, 1B, 1C . . . can be integrally held and fixed on one another, and each two adjacent battery modules can be electrically connected to each other. The example shown in FIGS. 16 to 18 corresponds to the case where the battery modules 1A, 1B, 1C . . . are connected in series. The first current lead 410 connected to a cell terminal 11N of the battery module 1A and the second current lead 420 connected to a cell terminal 11P of the adjacent battery module 1B are electrically connected to each other by the corresponding coupling portion 430.

Thus, the battery modules can be electrically connected to one another as they are fixed together, so that the number of assembly processes can be reduced, the operating efficiency can be improved, and the operator's load can be reduced.

By fixing the connecting members 400 by means of the fixing members 80, moreover, the connecting members 400 and cell terminals 11 can be positioned with respect to one another as they are secured to one another. After the battery modules 1A, 1B, 1C . . . are connected to one another, therefore, the cell terminals 11 and connecting members 400 can be easily laser-welded together without requiring a jig for clamping the connecting members 400 on the cell terminals 11.

The housing 90 described in connection with the first and second embodiments may also be used in this fifth embodiment. Further, the support 70 shown in FIG. 3 may be used so that the support 70 and housing 90 are fixed together.

This invention is not limited directly to the embodiment described above, and in carrying out the invention, its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

What is claimed is:

1. A battery pack comprising:
a battery module including a projection;
a support which holds the respective projections of a plurality of said battery modules disposed so that the projections are arranged in a straight line; and
a fixing member for fixing the support to the projections.

2. A battery pack according to claim 1, which further comprises a housing which contains the battery modules and a housing fixing member which secures the support to the housing.

3. A battery pack according to claim 1, which further comprises a current lead electrically connected to a cell terminal of the battery module and extending between the projection and the support, and a connecting member which is embedded in that surface of the support which faces the current lead and contacts the current lead, thereby electrically connecting the battery modules to one another.

4. A battery pack according to claim 2, which further comprises an elastic member disposed between the housing and the battery module.

5. A battery pack comprising:
a battery module;
a housing which contains a plurality of said battery modules disposed in a straight line between a first fixing plate extending substantially at right angles from a bottom plate and a tapered second fixing plate extending substantially at right angles from the bottom plate and reduced in thickness with distance from the bottom plate;
a wedge member interposed between the battery module and the second fixing plate of the housing; and
a fixing member for fixing the wedge member to the housing.

6. A battery pack according to claim 5, which further comprises an elastic member disposed between the housing and the battery module.

7. A battery pack comprising:
a battery module;
a fixing plate;
a movable pressure plate opposed to the fixing plate; and
an urging member which urges the pressure plate toward the fixing plate so as to hold the battery modules arranged in a straight line between the fixing plate and the pressure plate, thereby fixing the battery modules.

8. A battery pack comprising:
a battery module provided with a case including an open portion and a cell contained in the case; and
a lid member fitted to the case of each of a plurality of battery modules arranged in a straight line, thereby closing the open portion and fixing the battery modules.

9. A battery pack according to claim 8, which further comprises an elastic member disposed between the lid member and the battery module.

10. A battery pack comprising:
a battery module provided with a cell, which is composed of an electrode group and a non-aqueous electrolyte contained in an armor case and includes a cell terminal electrically connected to the electrode group and protruding outward from the armor case, and a case including a cell containing portion which contains the cell and a terminal hole through which the cell terminal of the cell projects;
a connecting member which is electrically connected to the cell terminal projecting through the terminal hole of the case of each of a plurality of battery modules arranged in a straight line and electrically connects the adjacent battery modules; and
a fixing member for fixing the connecting member to the case of each of the battery modules.
